(19) United States
(12) Patent Application Publication
(10) Pub. No.: US 2005/0170120 A1
(43) Pub. Date: Aug. 4, 2005

(54) Cured-in-place construction system and method

(76) Inventors: George P. Teitelbaum, Santa Monica, CA (US); Donald W. Larsen, La Canada, CA (US)

Correspondence Address: HOGAN & HARTSON L.L.P., 500 S. GRAND AVENUE, SUITE 1900, LOS ANGELES, CA, 90071-2611, US

(21) Appl. No.: 10/979,674

(22) Filed: Nov. 1, 2004

Related U.S. Application Data
(60) Provisional application No. 60/516,326, filed on Oct. 31, 2003.

(51) Int. Cl. B32B 1/08

(52) U.S. Cl. 428/36.91

(57) ABSTRACT

A construction system of a plurality of interlocking construction elements is disclosed. At least one of the interlocking elements is a cured-in-place element having a pliable exterior shell defining a cavity and a strength-imparting core placed inside the cavity. The system also includes a hardenable media for filling the cavity. The exterior shell of the cured-in-place element is adapted to expand as its cavity is filled with the hardenable media or as the hardenable media cures, whereby the interlocking construction elements bond into an integral structure by a an interference or a friction fit. Methods of construction of new structures and reinforcement of preexisting ones are also disclosed.

This application claims priority to the U.S. Provisional Patent Application Ser. No. 60/516,326, filed on Oct. 31, 2003.

### FIELD OF THE INVENTION

This invention relates to construction systems and methods and, in particular, to construction systems and methods utilizing interlocking cured-in-place construction elements.

### BACKGROUND OF THE INVENTION

Composite materials possess great strength and resiliency and are lighter than steel and many other building materials currently in use. Composite structures comprising polymeric outer layers and fiber-reinforced foam cores have been described, for example, in U.S. Pat. No. 4,910,067.

Due to their light weight and strength, various composite materials, including composites incorporating graphite and Kevlar® (poly-paraphenylene terephthalamide) fibers (DuPont™, Wilmington, Del.), have been widely used by the aerospace industry. Similarly, in the construction industry, composite materials have been used to make construction panels (U.S. Pat. No. 3,583,123) and structural frames for bridges, buildings, and ship decks (U.S. Pat. No. 5,644,888).

U.S. Pat. No. 3,583,123 describes foamed-in-place double-skin building panels adapted to be assembled with fasteners. The panels comprise an outer facing sheet, an inner facing sheet spaced from the outer facing sheet, and a foamed-in-place core filling the space between the sheets. The panels are first filled by the plastic foam core and then assembled into a structure with the fasteners.

U.S. Pat. No. 5,644,888 describes interfitting composite members forming a rigid post and beam or beam and brace structures. A first member has an internal channel having a continuous scalloped or toothed cross-section on both sides. The mating support member has a bifurcated end with outer sides configured to interlock with the sides of the internal channel. The bifurcated end of the insertion member compresses to be inserted into the channel of the cross-beam, where it expands and engages the scalloped walls of the I-beam and locks securely into place. A block is then used to secure the structure.

In addition to the construction of new buildings, often there is a need to strengthen and reinforce the frame and walls of existing buildings. The methods commonly used to date for strengthening walls include the addition of a new reinforced concrete wall to one or both faces of the existing wall. The new walls include steel reinforcement, which is tied to the surface(s) of the existing wall through anchor bolts. Then a layer of concrete (usually a few inches in thickness) is added or sprayed on top of the steel reinforcement. In essence, the old wall is sandwiched between the two new walls. This type of strengthening is not only time-consuming, but it also results in a significant increase in the weight of the externally reinforced wall. Because the forces produced during an earthquake are proportional to the weight of the structure, this added mass results in larger forces being applied to the structure. Moreover, in many instances, the existing foundations of the structure cannot support the weight of the newly-added walls; this leads to further expenses to strengthen the foundation (U.S. Pat. No. 5,640,825).

Thus, an unfulfilled need still exists for effective and economical methods of construction new buildings and strengthening the existing ones.

### SUMMARY OF THE INVENTION

Accordingly, an object of the present invention is to provide a construction system and methods that utilizes composite materials created by demand on site. Also, it is an object of the invention to provide a construction system and methods of constructing structures of high elasticity and capable of surviving severe shocks, such as earthquakes, hurricanes, and explosions. Also, it is an object of the invention to provide a construction system and method of assembling structural elements without mechanical fasteners, such as rivets and bolts, and without welding. It is still another object of the present invention to provide convenient and efficient methods of reinforcement of preexisting structures and foundations.

These and other objects are achieved by utilizing a construction system of the present invention comprising a plurality of interlocking construction elements and wherein at least one of the interlocking elements is a cured-in-place element. The cured-in-place element of the present invention comprises a pliable exterior shell defining a cavity and a strength-imparting core placed inside the cavity. The system further comprises a hardenable media for filling the cavity. In the present invention, the exterior shell of the cured-in-place element is adapted to expand as its cavity is filled with the hardenable media or as the hardenable media cures, whereby the interlocking construction elements bond into an integral structure by a an interference or a friction fit.

The strength-imparting core may comprise supportive fibers. The hardenable media may comprise a light-, heat-, or radio wave-curable polymer. In one embodiment, at least one of the interlocking elements is a connector having a body with at least one seating adapted for holding at least a portion of the cured-in-place construction element. The seatings may be in a form selected from a group consisting of holes, cavities, slots, fenestrations, and portals.

In another aspect, the present invention provides a method of construction. The method comprises: (a) providing a plurality of interlocking construction elements, wherein at least one of the interlocking elements is a cured-in-place element described above; (b) providing a hardenable media; (c) positioning the cured-in-place element in a desired configuration with the other interlocking construction elements; (d) filling the cavity of the cured-in-place element with the hardenable media; and (e) allowing the exterior shell of the cured-in-place element to expand as its cavity is filled with the hardenable media or as the hardenable media cures, whereby the interlocking construction elements bond into an integral structure by an interference or a friction fit.

In still another aspect, the present invention provides a method of reinforcement of a preexisting structure, in which the cured-in-place element described above is placed in a desired configuration not only with the other interlocking construction elements, but also with the preexisting structure. As the exterior shell of the cured-in-place element expands, the interlocking construction elements bond into an integral structure by an interference or a friction fit to reinforce the preexisting structure.

In yet another aspect, the present invention provides a method of forming a reinforced foundation. The method comprises placing the cured-in-place elements of the present invention into holes drilled to a desired depth in a bedrock or soil. The method further comprises filling the cavity of the cured-in-place elements with the hardenable media. As the exterior shell of the cured-in-place element expands, the cured-in-place elements become immobilized in the bedrock or soil. In one embodiment, the immobilized cured-in-place elements are used as anchors for a framework of a structure or a building.

The above-described system and methods of the present invention provide a number of unexpected advantages over the existing construction systems and methods that utilize composite materials. First, the cured-in-place elements of the present invention are filled with the hardenable media on-site, which makes their transportation and storage more economical. Second, because the cured-in-place elements are first positioned in a desired interlocking configuration and then inflated with the hardenable media to create an interference or friction fit, their assembly is greatly simplified and can be handled by fewer workers.

Unlike the cured-in-place elements of the present invention, conventional composite construction elements must first be filled with an epoxy and then assembled (after epoxy dries). Accordingly, during construction, the workers are required to manipulate much heavier structural elements as compared to the present invention. Also, in the conventional methods, pre-formed composite elements must be forced into interference fit with each other, which is a substantially more laborious procedure as compared to the approach of the present invention.

Third, the integral structure of the present invention will have strength comparable to that of a metal structure while providing a substantially higher structural elasticity. Thus, structures built in accordance with disclosures of the present invention would be better able to survive severe shocks, such as earthquakes, storms, hurricanes, and explosions, as compared to conventional structures.

Fourth, an entire building could be constructed according to the present invention from only a small variety of expandable exterior shells and other interlocking construction elements, such as connectors described in detail below, without the use of rivets, bolts, or welding. Since the system lends itself to rapid erection of buildings, it could be used by the military or other government agencies to quickly create buildings, bridges, and other vital structures near battle zones or disaster sites.

Finally, after the hardenable media cures, the tight fit between the cured-in-place elements and other interlocking construction elements becomes permanent and water-tight. This could be vital, especially in military situations, to rapidly construct docks, bridges, and causeways. Overall, the present invention makes erection of buildings, bridges, piers, pipelines, transmission towers, antennae, and the support structures of tunnels and mines more rapid, less complex, and, thus, more economical.

The invention is defined in the appended claims and is described below in its preferred embodiments.

### DESCRIPTION OF THE FIGURES

The above-mentioned and other features of this invention and the manner of obtaining them will become more apparent, and will be best understood by reference to the following description, taken in conjunction with the accompanying drawings, in which:

FIG. 1 is a schematic representation of a cured-in-place element according to one embodiment of the present invention.

FIGS. 2a and 2b schematically show interlocking of a cured-in-place element with a connector according to one embodiment of the present invention. FIG. 2a shows the cured-in-place element and the connector before the hardenable media is injected into the cavity of the cured-in-place element, and FIG. 2b shows the cured-in-place element and the connector after the hardenable media is injected into the cavity of the cured-in-place element.

FIGS. 3a-3e show various forms of the cured-in-place elements.

FIGS. 4a-4c schematically show different integral structures constructed using interlocking elements of the present invention. FIG. 4a shows a frame of a building; FIG. 4b shows a flooring material; FIG. 4c shows a portion of a shock-absorbing framework.

FIGS. 5a-5k schematically show connectors according to a number of embodiments of the present invention. Connectors in a form of octagonal prisms (FIG. 5a), cubes (FIG. 5b), triangular prisms (FIG. 5c), and rectangular prisms (FIG. 5k) are shown. Also shown are cylindrical connector bodies (FIGS. 5d, 5g) and connector bodies comprising a combination of flat and curved surfaces (FIGS. 5e, 5f).

FIGS. 6a-6c depict integral structures comprising rod-like cured-in-place elements and connectors having a shape of an octagonal prism (FIG. 6a), a pyramid (FIG. 6b), and a cylinder (FIG. 6c) in accordance with some embodiments of the present invention.

FIGS. 7a and 7b show the formation of an interwoven structure of cured-in-place elements according to one embodiment of the present invention.

FIG. 8 shows a rolled up tubular exterior shell that may be cut into segments of the required length according to another embodiment of the present invention.

FIGS. 9a and 9b schematically show the assembling of a plurality of tubular cured-in-place elements to form a pipe. Adjacent cured-in-place elements may be bound utilizing their mating surfaces (FIG. 9a) or a ring connector (FIG. 9b).

FIGS. 10a and 10b schematically show the reinforcement of a preexisting building according to one embodiment of the present invention.

FIG. 11 schematically shows the reinforcement of a concrete foundation.

### DETAILED DESCRIPTION OF THE INVENTION

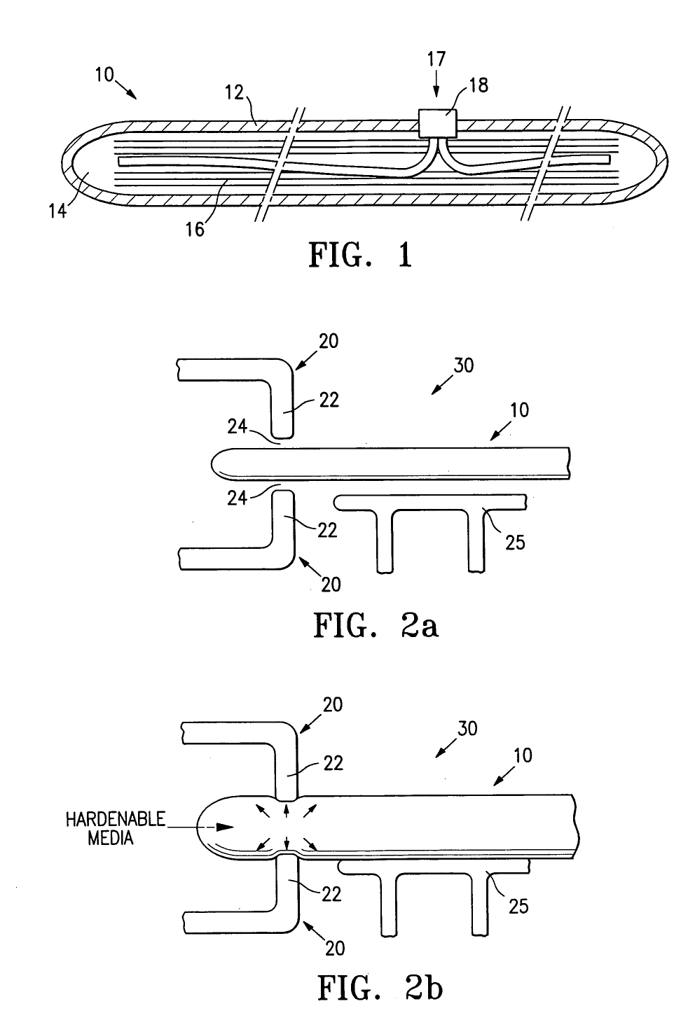

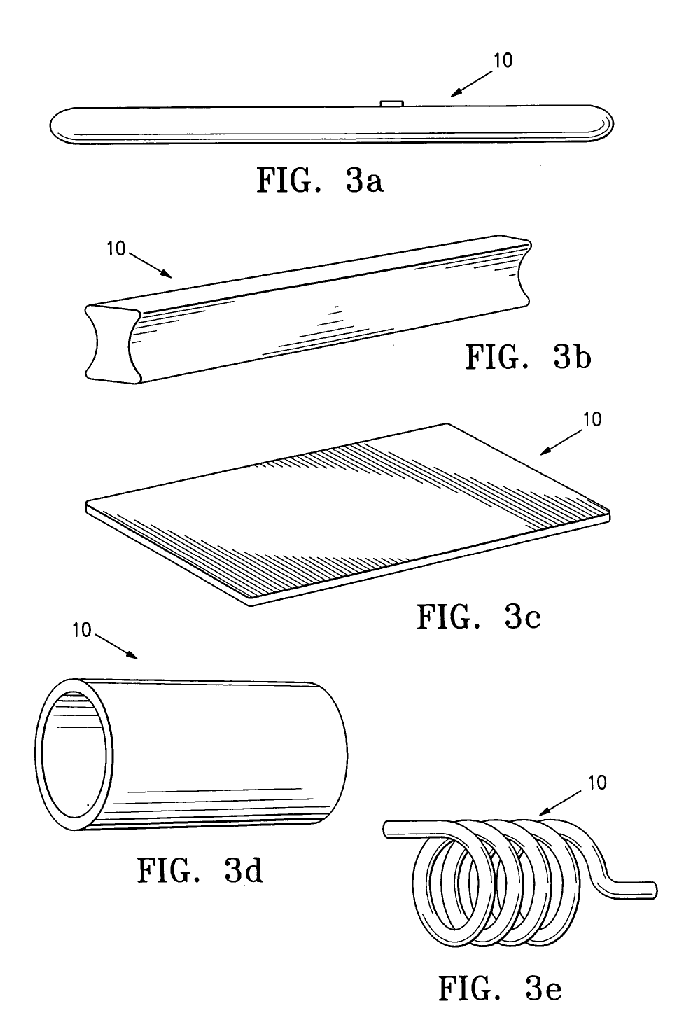

In one aspect, the present invention is directed to a construction system comprising a plurality of interlocking construction elements 10 and 20. Referring to FIGS. 1, 2a, and 2b, at least one of the interlocking elements is a cured-in-place element 10, comprising (i) a pliable exterior shell 12 defining a cavity 14 and (ii) a strength-imparting core 16 placed inside the cavity 14; and a hardenable media for filling the cavity. The exterior shell 12 of the cured-in-place element 10 is adapted to expand as its cavity 14 is filled with the hardenable media or as the hardenable media cures, whereby the interlocking construction elements 10 and 20 bond into an integral structure 30 by an interference or a friction fit.

Exterior Shell:

The exterior shell 12 may be made of any material as long as it is sufficiently pliable to allow the expansion of the shell when it is filled with the hardenable media or when the media hardens. For example, the shell may be made of a suitable polymer material. In some applications, such as an under water construction, it would be advantageous to make the shell out of a flexible water- and air-tight polymer material. In one embodiment, the exterior shell comprises a thermoplastic or a thermoset resin material. Those skilled in the art will be available to identify and select specific materials with the desired pliable properties.

The exterior shell may be formed into a desired shape by any of numerous different molding processes that are currently, or later become, known to those of ordinary skill in the pertinent art including, but not limited to, sheet extrusion, vacuum forming, and injection molding. The exterior shell may have one or more layers depending upon the properties ultimately sought to be exhibited by the cured-in-place elements.

The exterior shell may be integral or may be made from two or more pre-formed components attached to each other to form a cavity therebetween. Methods of attachment of pre-formed components are known in the art and include, for example, methods utilizing adhesives and thermal-setting methods, in which the contact areas of the pre-formed components are heated to a near molten state. The adhesive may be a pressure-sensitive adhesive, and/or a radiation activatable adhesive, such as a light-activated or UV-activated adhesive. For example, an adhesive containing a light-activated curing agent can be formulated with an acrylated urethane including a photo-initiator such that the adhesive can be cured upon exposure to a light source.

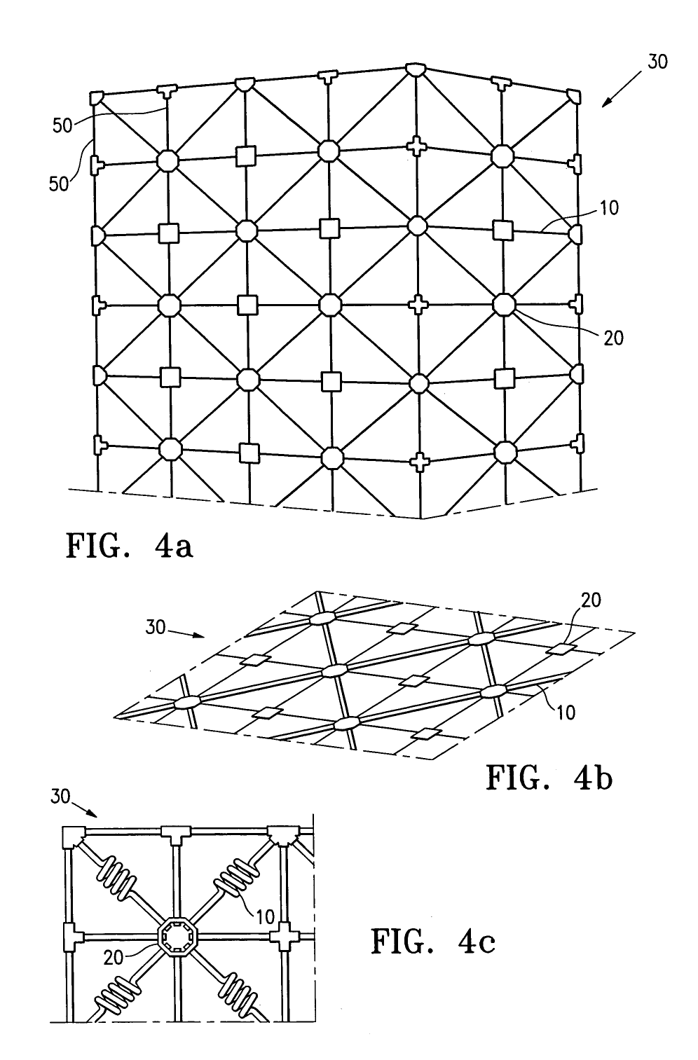

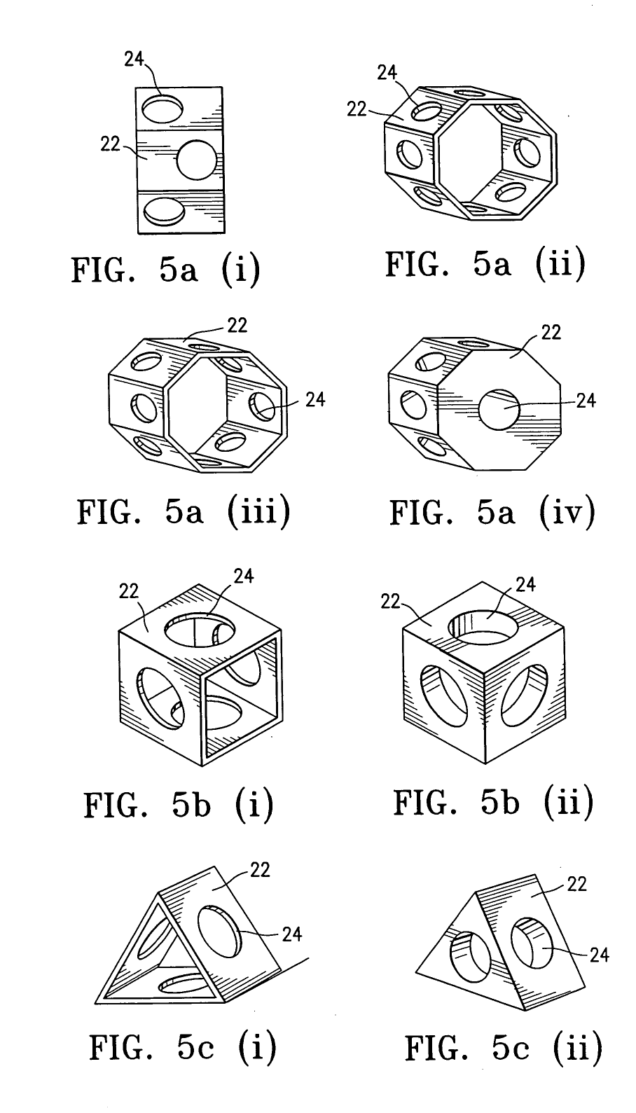

The interference or the friction fit of the present invention may be facilitated by fabricating the exterior shell of the cured-in-place elements in a variety of interlocking shapes. For example, as shown in FIGS. 3a-3e, the cured-in-place elements may be in the shape of a rod (FIG. 3a), a beam, e.g., I-beam (FIG. 3b), a flat or curved sheet, a band (FIG. 3c), a hollow cylinder, tube, a pipe segment (3d), or a spring (FIG. 3e). Spring-like cured-in-place elements (FIG. 3e) of the present invention, for example, may be used to act like shock absorbers, lending greater flexibility and resiliency to buildings, particularly in case of an earthquake (FIG. 4c).

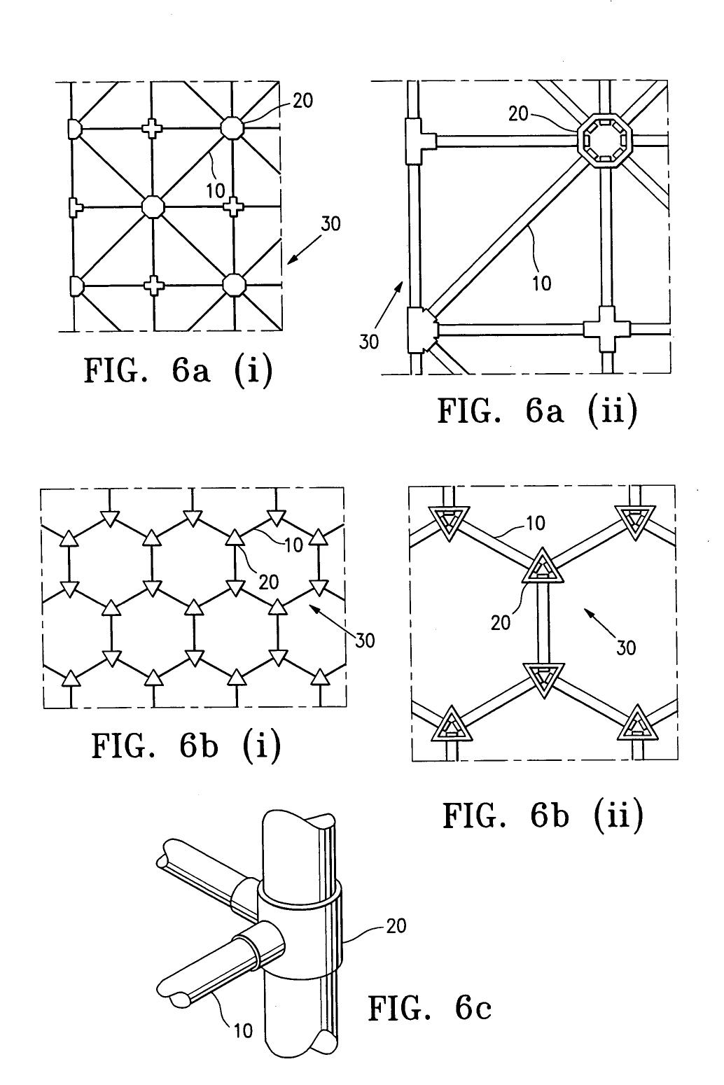

The cured-in-place elements may have other shapes, including struts and arches. Thinner tubular cured-in-place elements 10 may be interwoven with each other or other interlocking construction elements and then inflated with the hardenable media to create flat woven surfaces that may be used as floors or walls (FIGS. 7a and 7b).

Referring to FIGS. 2a and 2b, a removable scaffolding 25 may be used to retain the cured-in-place elements in a desired shape during curing of the hardenable media. In one embodiment, rod-like or tubular exterior shells have sufficient deformability such that they could be molded by the scaffolding into more complex shapes like arches.

Strength-Imparting Core:

The type of the strength-imparting core 16 material and/or location, orientation, and number of layers of such material are selected to impart to the cured-in-place elements impact resistance, modulus stiffness, tensile strength, compressive strength, bending, compression, torque, an advantageous coefficient of thermal expansion, and/or other desired properties.

In one embodiment shown in FIG. 1, the strength-imparting core comprises supportive fibers. The fibers may be placed individually in a spaced-apart relationship or in one or more bundles of multiple strands. In one embodiment, the fibers are woven together. The fibers may be any fibers that are currently known or later become known for performing the strength-imparting function. In one embodiment, the fibers are selected from a group consisting of glass, carbon, graphite, plant-based fibers, synthetic high strength materials, such as Kevlar® (poly-paraphenylene terephthalamide) fibers (DuPont™, Wilmington, Del.), and their combinations. In one embodiment, carbon or graphite fibers are produced using rope made of plant fibers, such as hemp, heated in a non-oxygen environment.

In one embodiment, fibers are attached to the inside of the shell to hold them in place during the injection of the hardenable media. The fibers may be attached by means known to those in the art, including mechanical fasteners made of a material compatible with the material of the exterior shell and adhesives. The adhesive may be a pressure-sensitive adhesive, and/or a radiation activatable adhesive.

The strength-imparting core may be comprised of random mat fibers, unidirectional fibers, bi-directional fibers, other multi-directional fibers, and/or multiple layer fabrics with reinforcement plies in at least two directions. A particular configuration of fibers may be selected to impart a variety of desired physical characteristics to the cured-in-place elements. For example, a unidirectional or bi-directional fiber predictably enhances the strength of the composite structure in the directions of the fibers. A directional fiber also may provide increased stiffness in comparison to a random mat fiber. Alternatively, a random mat fiber typically provides greater resistance to deformation and crack propagation than does a directional fiber.

In accordance with the preferred embodiment of the present invention, the strength-imparting core material must exhibit sufficient permeability to permit an adequate flow of the hardenable media through the core as described further below. Several characteristics of the core material may affect its permeability, and therefore may affect this desired result. When the core material comprises a bundle of fibers, the density of the fibers in the bundle, for example, may affect the permeability of the bundle. If the fibers in a bundle are pulled too tightly together, the hardenable media, in its uncured state, will flow around the bundle and may not wet the individual fibers.

Further details of selecting appropriate materials for pliable exterior shells and strength-imparting core, methods of their manufacturing, and methods of their assembling are known to those skilled in the art and won't be discussed here. Such details could be found, for example, in the U.S. patent application Ser. No. 09/981,083, filed Oct. 16, 2001 (U.S. Patent publication No 200220102390), incorporated herein by the reference in its entirety.

Hardenable Media:

The hardenable media may be any material that exhibits a resinous character and impregnates the strength-imparting core when injected into the cavity of the exterior shell. The hardenable media may also comprise materials capable of expanding inside the cavity as they cure. One example of such expandable hardenable media is foam, but other expandable materials may also be used. The hardenable media may be a liquid resin, such as polyester, vinyl ester, etc., or a liquid adhesive, which includes all types of epoxies. Preferably, the liquid resin or adhesive is a material that cures quickly so as to prevent the material of the strength-imparting core, such as fibers, from shifting within the core of the cured-in-place element.

In one embodiment, the hardenable media comprises a polymer selected from a group consisting of epoxy resins, polyurethanes, silicone polymers, copolymers of alkyl acrylates and/or alkyl methacrylates, oxyalkylene polymers, ethyl-methyl ketone resins, foams, and other curable polymers.

In one embodiment, the hardenable media is a polymer capable of curing within 12 hours after being injected into the cavity. For the purposes of the present invention, the terms “curing” and “cures” mean stiffening, foaming, or setting of the hardenable media.

The hardenable media may be a “radiation- or heat-curable” material. In one embodiment, as soon as the cured-in-place element is filled with the hardenable media, an external (placed outside of the cavity) or an internal (placed inside the cavity) source of heat or radiation is turned on and the hardenable media turns into a solid or a semi-solid (e.g., a gel) state within a short period of time. Examples of such external and internal sources of energy include, but are not limited to, electrical resistance, inductive, optical, convective heating, infrared, UV, and radio frequency transmitting elements. In one embodiment, a resistive heater positioned inside the cavity.

Advantageously, the strength and flexibility of the cured-in-place elements may be adjusted by appropriately selecting materials for the exterior shell, strength-imparting core, and hardenable media. Also, advantageously, before the hardenable media is injected, the exterior shell of the cured-in-place elements with their strength-imparting core would weigh significantly less than conventional steel and composite structural elements, allowing easier transport, handling, and deployment of the cured-in-place elements of the present invention. For example, uninflated cured-in-place elements of the present invention may be carried and positioned for deployment by several workers as opposed to using a crane to move and position steel structural elements.

Optional Features of the System:

Referring to FIG. 1, in one embodiment, the exterior shell of the cured-in-place elements further comprises a port 17 connecting the cavity 14 with an exterior. Preferably, the port 17 comprises a self-sealing valve 18 in order to prevent leakage of the hardenable media as it cures inside the cavity 14. The hardenable media may be injected into the cavity 14 by a mechanized liquid polymer pump (not shown) at a carefully controlled pressure. Once the filling is complete, the delivery line or hose from the pump may be withdrawn from a self-sealing valve.

In one embodiment, the air within the exterior shell is vacuumed out before injecting the hardenable media, thus ensuring no air bubbles or pockets within the resultant composite material.

Referring to FIGS. 2a and 2b, in one embodiment, at least one of the interlocking elements is a connector 20 having a body 22 with at least one seating 24 adapted for holding at least a portion of the cured-in-place element 10. Once inserted into the seating, the cured-in-place element 10 is filled with the hardenable media and forms a tight interference fit within the seating 24 of the connector 20. If the cured-in-place element has to be removed after curing, it can be cut with a saw. If a leak of the hardenable media were to be detected during the injection, it could be sealed by a manually-applied, self-adhesive patch made of a material compatible with that of the shell.

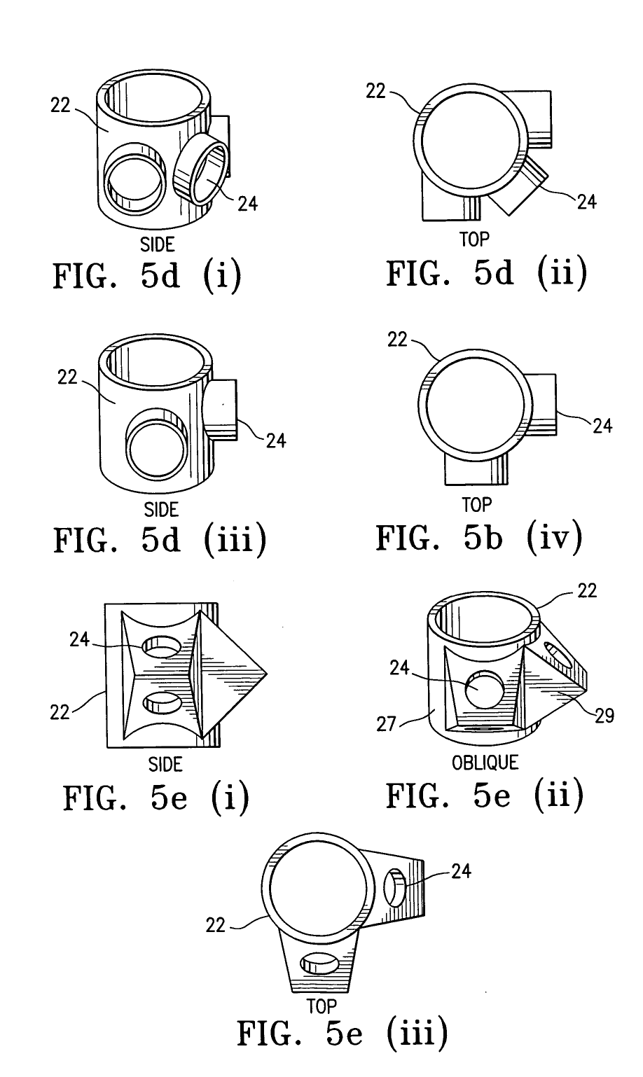

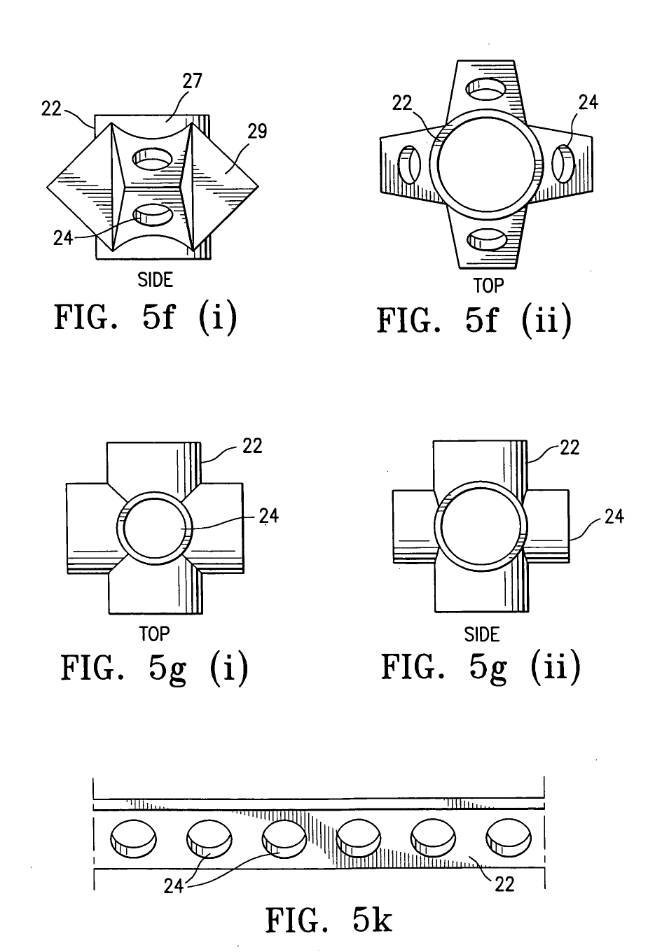

The bodies 22 and the seatings 24 of the present invention may be in any form as long as they are capable of holding at least a portion of the cured-in-place element. Some examples of the seatings include, but are not limited to, holes (FIGS. 5a(i-iii), 5b(i), 5c(i), 5f, 5g, cavities (FIGS. 5a(iv), 5b(ii), 5c(ii), 5d, slots (FIGS. 2a and 2b), fenestrations, and portals (FIG. 5k). Connector bodies 22 may be polyhedrones, including but not limited to, octagonal prisms (FIG. 5a), cubes (FIG. 5b), triangular prisms (FIG. 5c), and rectangular prisms (FIG. 5k). Connector bodies may also be cylinders (FIGS. 5d, 5g), pyramids (FIG. 6b(i)), spheres, cones, or other three-dimensional figures combining flat 29 and curved 27 surfaces (FIGS. 5e, 5f). In one embodiment, the connector has at least one side comprising at least two seatings. For example, a connector may be a band with multiple seatings (FIG. 5k). Referring to FIGS. 6a-c, integral structures 30 comprising rod-like cured-in-place elements 10 and connectors 20 having a shape of an octagonal prism (FIG. 6a), a pyramid (FIG. 6b), and a cylinder (FIG. 6c) are shown.

The connectors may be made of any suitable material that is able to withstand a pressure from the interference fit, including, but not limited to, metals and alloys, with or without polymer coatings, plastics, and composite materials. The composite composition would have the advantage of decreased weight relative to alloys, such as steel.

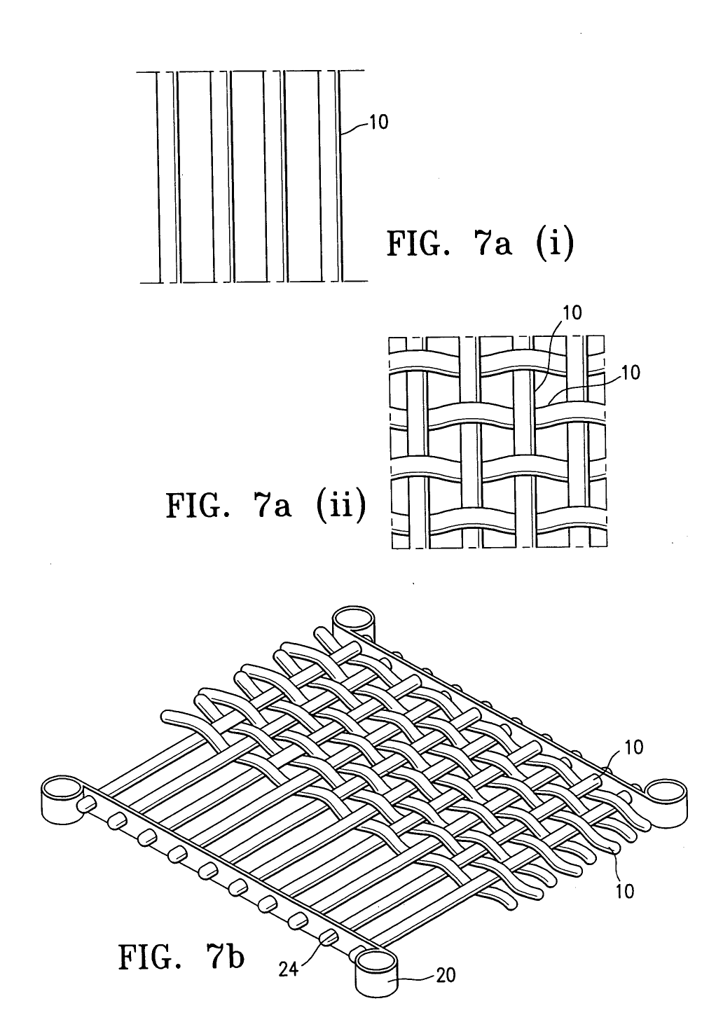

Referring to FIG. 8, long, tube-like expandable exterior shells 12 containing the strength-imparting core may be compressed and rolled-up on a reel 40 like a fire hose. When custom-length composite rods or beams would be required to link connectors at a construction job site, these rod lengths would be produced on the spot by rolling out the required length of uninflated exterior shell and then cutting off the required segment 42. The cut ends 44 of the segment 42 may then be sealed by mechanical (e.g., a clamp), thermal, or adhesive means. This would allow containment of the strength-imparting core and hardenable media within the shell. Self-sealing valves for injection of the hardenable media could then be added.

Accordingly, in one embodiment of the present invention, the cured-in-place element has an elongated shape and is formed by a method comprising the steps:
(i) forming an elongated shell with the strength-imparting core;
(ii) cutting the elongated shell and the core to form the cured-in-place elements of the predetermined length; and
(iii) sealing ends of the cut cured-in-place elements obtained in the step (ii).

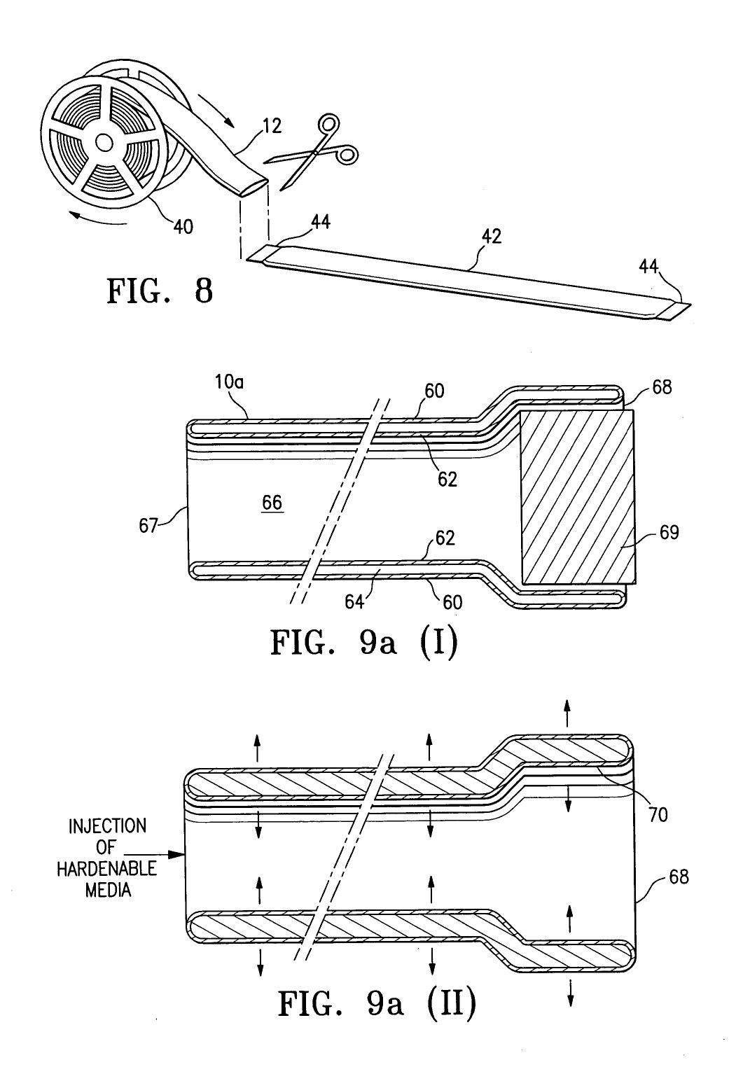

The system of the present invention may be used for building any structures where conventional construction materials are used. For example, the integral structure built in accordance with embodiments of the present invention may be a building frame (FIG. 4a), a pipe (FIGS. 9a and 9b), or an interwoven flat sheet flooring or wall material (FIG. 4b). For example, a frame structure comprising cured-in-place elements 10 and connectors 20 may be formed (FIG. 4a). Then, the drywall and windows may be attached to the outer cured-in-place elements 50 of the frame. Then, flooring material made of cured-in-place elements 10 with connectors 20 (FIG. 4b) may be layered into the horizontal framework of each floor.

Referring to FIGS. 7a and 7b, in one embodiment, interwoven sheets of cured-in-place elements 10 are used as flooring or wall material. The exterior shells are interwoven, filled with the hardenable media, and cured. The desired final “sheet” contour (i.e., flat or curved) may be maintained by external bracing or scaffolding (not shown) until the cured-in-place elements are cured. The bracing elements are then removed. The interwoven sheets may be connected to a larger framework of a building by band-like connectors 20 with a plurality of seatings 24. Some of the seatings may be used to fit ends of the interwoven cured-in-place elements, while others may be used to connect other structural elements of the larger framework.

In one embodiment, long straight log-like components are interlocked with straight log-like components having a fenestration or portal at either or both ends and/or at their centers. The fenestrated components would be deployed and inflated with hardenable media in a vertical position. Once these components have hardened, uninflated non-fenestrated components would be positioned through the fenestrations/portals of the vertical components and would then be inflated and distended with the hardenable media, thus creating a tight fit with the vertical components.

Referring to FIGS. 9a and 9b, in one embodiment, the construction system comprises a plurality of the cured-in-place elements 10a having a tubular shape for building pipe. Each tubular cured-in-place element has two concentric walls 60 and 62 forming cavity 64 therebetween for filling with the hardenable media. The tubular cured-in-place elements 10a have a central channel 66 for transport of liquids or gases and two ends 67 and 68.

Adjacent cured-in-place elements may have mating surfaces 70 and 72 that lock in place when the hardenable media cures. Such mating surfaces may, for example be created by means of a removable template 69, as shown in FIG. 9a (I and II).

In this embodiment, the removable template 69 is placed inside an uninflated cured-in-place element adjacent to its one end 68 (FIG. 9a(I)). Then, the hardenable media is injected and is allowed to cure, after which the template is removed, whereby the matting surface 70 is formed (FIG. 9a (II)). Then, a first end 74 of the next uninflated cured in-place element 10b may be inserted into the receiving end 68 of the first uninflated cured in-place element 10a, while its second end is expanded by means of the template 69 (FIG. 9a (III) and (IV)). The process is then repeated for successive pipe sections. Alternatively, exterior shells of pipe sections with mating surfaces may be pre-formed.

In another embodiment shown in FIG. 9b, adjacent cured-in-place elements are connected by a ring connector 76 having two circumferential lips 78 and 80. Each cured-in-place element 10 has a circumferential channel 82 formed on its exterior near each of its ends, wherein the channel 82 and the lip 78 bond when the hardenable media cures.

This system could rapidly create composite pipelines either above or under ground or underwater. This system would have the advantage of creating pipelines (especially under emergency or battle zone conditions) using light-weight components that could be transported to the site of need much more easily and rapidly than metal or concrete pipeline components. Such composite pipeline components, once properly fitted together and positioned, could be inflated with the hardenable media in situ underwater.

In another aspect, the present invention provides a method of construction. The method comprises: (a) providing a plurality of interlocking construction elements, wherein at least one of the interlocking elements is a cured-in-place element described above; (b) providing a hardenable media; (c) positioning the cured-in-place element in a desired configuration with the other interlocking construction elements; (d) filling the cavity of the cured-in-place element with the hardenable media; and (e) allowing the exterior shell of the cured-in-place element to expand as its cavity is filled with the hardenable media or as the hardenable media cures, whereby the interlocking construction elements bond into an integral structure by a an interference or a friction fit.

In one embodiment, at least one of the interlocking elements is a connector having a body with at least one seating 24, wherein the step (c) further comprises fitting at least a portion of the cured-in-place element into the seating. In another embodiment, the integral structure is built under water and step (c) of the method further comprises positioning the cured-in-place elements and the other interlocking construction elements in a desired configuration under the water.

In another embodiment, the method of the present invention further comprises a step of designing the cured-in-place element with a desirable strength and flexibility by selecting materials for the exterior shell, the strength-imparting core, and the hardenable media.

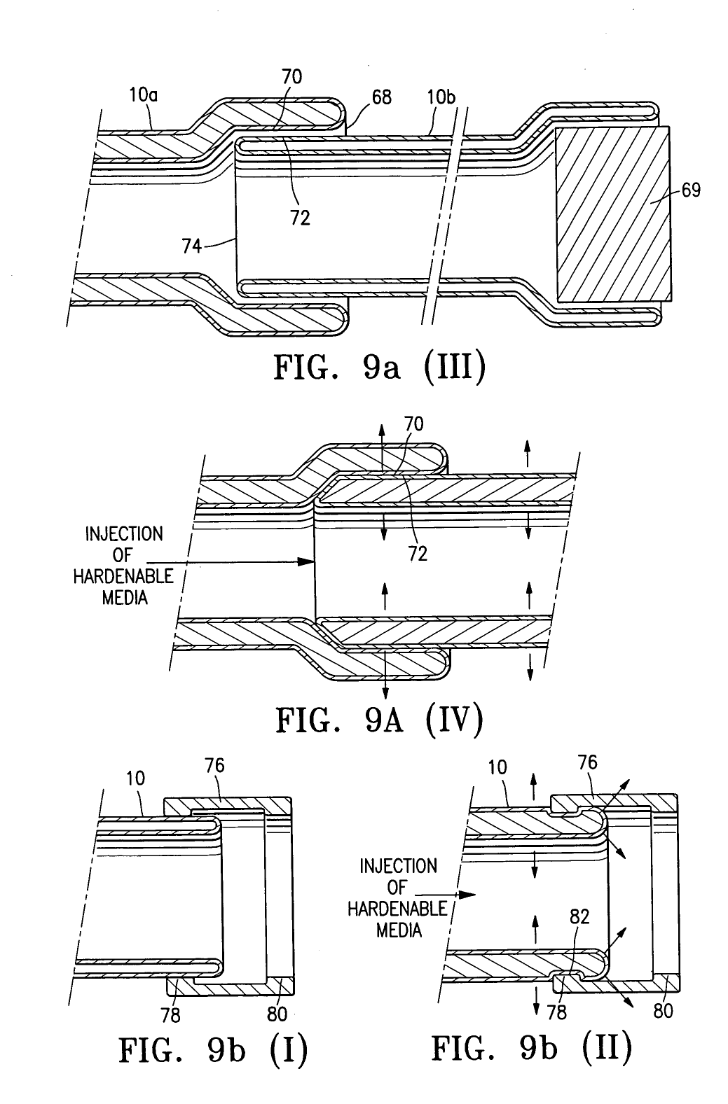

In another aspect, the present invention provides a method of reinforcement of a preexisting structure. Referring to FIGS. 10a and b, the method comprises positioning the cured-in-place elements of the present invention 10 in a desired configuration with the other interlocking construction elements 20 and the preexisting structure 90; filling the cavity of the cured-in-place element with the hardenable media; and allowing the exterior shell of the cured-in-place element to expand as its cavity is filled with the hardenable media or as the hardenable media cures, whereby the interlocking construction elements bond into an integral structure 30 by a an interference or a friction fit to reinforce the preexisting structure 90.

In one embodiment, the method further comprises forming at least one conduit 92 through the preexisting structure and placing an unexpanded cured-in-place element 10 through the conduit. The hardenable media is injected into the cured-in-place element and is cured to create a tight fit between the cured-in-place element and the conduit. Unlike conventional methods of reinforcing buildings that require tearing apart a wall to insert a steel girder or wooden beams, the present invention calls simply for one or more channels to be drilled within the walls while saving its external appearance.

These cured-in-place elements extending into the unstable building may be linked with an external composite framework, which itself may be created from connectors 20 and interlocking cured-in-place elements. A number of these cured-in-place elements of the framework may be sunk into and expanded within holes made in the ground surrounding the retrofitted building.

The instant reinforcing method may be used to reinforce framework of large concrete construction projects including freeways, bridges, retaining walls, tunnels, reservoirs, etc. The system may also be used to reinforce mineshafts and tunnels.

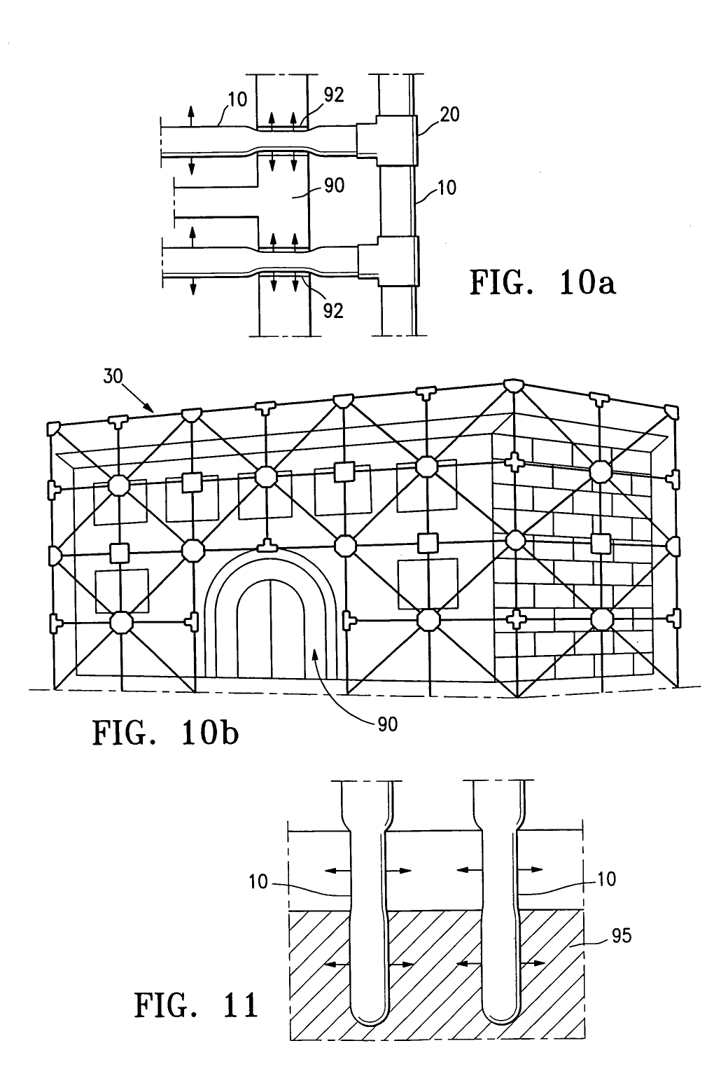

In a different aspect, the present invention provides a method of forming a reinforced foundation. In reference to FIG. 11, the method comprises: drilling holes of a desired depth into a bedrock or soil 95; placing the cured-in-place elements 10 of the present invention into the holes; filling the cavity of the cured-in-place elements with the hardenable media; and allowing the exterior shell of the cured-in-place element to expand as its cavity is filled with the hardenable media or as the hardenable media cures, whereby the cured-in-place elements become immobilized in the bedrock or soil. In one embodiment, the immobilized cured-in-place elements serve as anchors for a framework of a structure or a building.

The same method may be used for the reinforcement of a preexisting foundation. Deep holes may be drilled in a preexisting foundation and into the soil or bedrock at the base of the building. Uninflated straight cured-in-place elements may be lowered into these holes and expanded to create a tight fit, thereby creating anchoring points for the rest of the building's superstructure. One advantage of the instant method of foundation reinforcement is that it allows to increase the elasticity of the building's superstructure. This may increase the likelihood of a building's survival in case of an earthquake, explosion, hurricane, storm, or other types of severe weather.

It will be apparent to those skilled in the art that various modifications and variations can be made in system and methods of the present invention without departing from the spirit or scope of the inventions. Thus, it is intended that the present invention cover modifications and variations of this invention that come within the scope of the appended claims and their equivalents.

1. A construction system comprising:
a plurality of interlocking construction elements, wherein at least one of the interlocking elements is a cured-in-place element comprising:
a pliable exterior shell defining a cavity and
a strength-imparting core placed inside the cavity; and
a hardenable media for filling the cavity,
wherein the exterior shell of the cured-in-place element is adapted to expand as its cavity is filled with the hardenable media or as the hardenable media cures, whereby the interlocking construction elements bond into an integral structure by a an interference or a friction fit.

2. The construction system of claim 1, wherein the strength-imparting core comprises supportive fibers.

3. The construction system of claim 1, wherein the supportive fibers are selected from a group consisting of carbon, graphite, glass, plant-based fibers, synthetic fibers, and their combination.

4. The construction system of claim 1, wherein the exterior shell comprises a flexible water- and air-tight polymer material.

5. The construction system of claim 1, wherein the hardenable media comprises a radiation- or heat-curable polymer.

6. The construction system of claim 1, wherein the hardenable media comprises a polymer selected from a group consisting of epoxy resins, polyurethanes, silicone polymers, copolymers of alkyl acrylates and/or alkyl methacrylates, oxyalkylene polymers, ethyl-methyl ketone resins, foams, and other curable polymers.

7. The construction system of claim 6, wherein the polymer is capable of curing within 12 hours after being injected into the cavity.

8. The construction system of claim 1, wherein the exterior shell further comprises a port connecting the cavity with an exterior.

9. The construction system of claim 8, wherein the port comprises a self-sealing valve preventing leakage of the hardenable media as it cures inside the cavity.

10. The construction system of claim 1, wherein at least one of the interlocking elements is a connector having a body with a seating adapted for holding at least a portion of the cured-in-place element.

11. The construction system of claim 10, wherein the seating is in a form selected from a group consisting of holes, cavities, slots, fenestrations, and portals.

12. The construction system of claim 10, wherein the body of the connector is selected from a group consisting of polyhedrones, pyramids, cylinders, spheres, cones, or other three-dimensional figures combining flat and curved surfaces.

13. The construction system of claim 10, wherein the connector has at least one side comprising at least two seatings.

14. The construction system of claim 10, wherein the connector is made of a metal, a plastic, or a composite material.

15. The construction system of claim 1 further comprising an external source of energy placed outside of the cavity, an internal source of energy placed inside the cavity, or both for accelerating the curing of the hardenable media.

16. The construction system of claim 15, wherein the external source of energy and the internal source of energy are selected from a group consisting of electrical resistance, inductive, optical, convective heating, and radio frequency transmitting elements.

17. The construction system of claim 16, wherein the heat source is a resistive heater positioned in the cavity.

18. The construction system of claim 1, wherein the interlocking construction elements have a predetermined size and a shape selected from a group consisting of rods, beams, pipe segments, struts, arches, I-beams, sheets, bands, tubes, and springs.

19. The construction system of claim 1, wherein the cured-in-place element has an elongated shape and is formed by a method comprising the steps:
(i) forming an elongated shell with the strength-imparting core;
(ii) cutting the elongated shell and the core to form the cured-in-place elements of the predetermined length; and
(iii) sealing ends of the cut cured-in-place elements obtained in the step (ii).

20. The construction system of claim 19, wherein the elongated shell is adapted to be compressed and rolled-up on a reel prior to the cutting step.

21. The construction system of claim 1, wherein the integral structure is a building frame, a pipe, or an interwoven flat sheet flooring or wall material.

22. The construction system of claim 1 further comprising a removable scaffolding for maintaining the cured-in-place elements in a desired shape during curing of the hardenable media.

23. The construction system of claim 1 having a plurality of the cured-in-place elements having a tubular shape, wherein each tubular cured-in-place element has two concentric walls forming the cavity therebetween and two ends, wherein the integral structure is a pipe.

24. The construction system of claim 23, wherein adjacent cured-in-place elements have mating surfaces that lock in place when the hardenable media cures.

25. The construction system of claim 23, wherein adjacent cured-in-place elements are connected by a ring connector having two circumferential lips, wherein each cured-in-place element has a circumferential channel formed on its exterior near each of its ends, wherein the channels and the lips bond when the hardenable media cures.

26. A method of construction comprising:
(a) providing a plurality of interlocking construction elements, wherein at least one of the interlocking elements is a cured-in-place element comprising:
a pliable exterior shell defining a cavity therein and
a strength-imparting core placed inside the cavity; and
(b) providing a hardenable media;
(c) positioning the cured-in-place element in a desired configuration with the other interlocking construction elements;
(d) filling the cavity of the cured-in-place element with the hardenable media; and
(e) allowing the exterior shell of the cured-in-place element to expand as its cavity is filled with the hardenable media or as the hardenable media cures, whereby the interlocking construction elements bond into an integral structure by a an interference or a friction fit.

27. The method of claim 26, wherein the hardenable media expands inside the cavity as it cures.

28. The method of claim 26, wherein at least one of the interlocking elements is a connector having a body with at least one seating, wherein the step (c) further comprises fitting at least a portion of the cured-in-place element into the seating.

29. The method of claim 26, wherein the integral structure is built under water and step (c) of the method further comprises positioning at least one cured-in-place element and the other interlocking construction elements in a desired configuration under the water.

30. The method of claim 26, further comprising a step of designing the cured-in-place element with a desirable strength and flexibility by selecting materials for the exterior shell, the strength-imparting core, and the hardenable media.

31. The method of claim 30, wherein the strength-imparting core comprises a supportive fiber bundle and the designing step further comprises selecting orientation and number of supportive fibers in the bundle.

32. The method of claim 26, wherein the cured-in-place element has a rod-like shape and wherein the providing step (a) comprises:
(i) forming an elongated tubular shell with the strength-imparting core;
(ii) cutting the tubular shell with the core to form the cured-in-place elements of a desired length; and
(iii) sealing ends of the cut cured-in-place elements obtained in the step (ii).

33. The method of claim 32 further comprising adding ports with self-sealing valves to the cured-in-place elements obtained in the step (iii).

34. The method of claim 33, wherein the cutting is carried out at a construction site.

35. The method of claim 34 further comprising a step of compressing the elongated shell and rolling it up on a reel prior to the bringing it to the construction site.

36. The method of claim 26, wherein the integral structure is an interwoven flat sheet and the step (c) further comprises interweaving the cured-in-place elements.

37. The method of claim 36, wherein at least one interlocking element is a band-like connector having a body with at least two seatings wherein the step (c) further comprises fitting ends of the interwoven cured-in-place elements in the seatings.

38. The method of claim 37 further comprising a step of using the band-like connector to connect the interwoven flat sheet with other structural elements of a building.

39. The method of claim 26, wherein the step (c) further comprises providing a scaffolding for supporting the cured-in-place elements in the desired configuration.

40. A method of reinforcement of a preexisting structure, the method comprising:
(a) providing a plurality of interlocking construction elements, wherein at least one of the interlocking elements is a cured-in-place element comprising:
a pliable exterior shell defining a cavity therein and
a strength-imparting core placed inside the cavity; and
(b) providing a hardenable media;
(c) positioning the cured-in-place element in a desired configuration with the other interlocking construction elements and the preexisting structure;
(d) filling the cavity of the cured-in-place element with the hardenable media; and
(e) allowing the exterior shell of the cured-in-place element to expand as its cavity is filled with the hardenable media or as the hardenable media cures, whereby the interlocking construction elements bond into an integral structure by a an interference or a friction fit to reinforce the preexisting structure.

41. The method of claim 40, wherein step (c) further comprises steps of forming at least one conduit through the preexisting structure and placing an unexpanded cured-in-place element through the conduit.

42. The method of claim 40 further comprising a step of forming a reinforced foundation, wherein the step comprises:
(i) drilling holes to a desired depth into a bedrock or soil;
(ii) providing cured-in-place rod-like elements having a general rod or beam shape;
(iii) placing the rod-like cured-in-place elements into the holes;
(iv) filling the cavity of the rod-like cured-in-place elements with the hardenable media; and
(v) allowing the exterior shell of the cured-in-place element to expand as its cavity is filled with the hardenable media or as the hardenable media cures, whereby the rod-like cured-in-place elements become immobilized in the bedrock or soil.

43. The method of claim 42 further comprising a step of using the immobilized cured-in-place elements as anchors for the integral structure.

44. The method of claim 42, wherein the holes are drilled through an existing foundation.

45. A method of forming a reinforced foundation comprising:
(a) drilling holes of a desired depth into a bedrock or soil;
(b) providing cured-in-place elements having a general rod or beam shape and comprising:
a pliable expandable exterior shell defining a cavity therein and
a strength-imparting core placed inside the cavity;
(c) placing the cured-in-place elements into the holes;
(d) providing a hardenable media;
(e) filling the cavity of the cured-in-place elements with the hardenable media; and
(e) allowing the exterior shell of the cured-in-place element to expand as its cavity is filled with the hardenable media or as the hardenable media cures, whereby the cured-in-place elements become immobilized in the bedrock or soil.

46. The method of claim 45 further comprising a step of using the immobilized cured-in-place elements as anchors for a framework of a structure or a building.
